(19) United States
(12) Patent Application Publication
(10) Pub. No.: US 2022/0057499 A1
(43) Pub. Date: Feb. 24, 2022

(54) SYSTEM AND TECHNIQUES FOR CLIPPING SONAR IMAGE DATA

(71) Applicant: CODA OCTOPUS GROUP, INC., Orlando, FL (US)

(72) Inventor: Martyn Sloss, East Wemyss (GB)

(21) Appl. No.: 16/998,210

(22) Filed: Aug. 20, 2020

(51) Int. Cl. G01S 7/53; G01S 7/295; G06T 15/08; G06T 7/62

(52) U.S. Cl. CPC G01S 7/53; G06T 7/62; G06T 15/08; G01S 7/2955

(57) ABSTRACT

Technologies for processing imaging data are disclosed, such as sonar images. A computing device obtains a three-dimensional (3D) volumetric view of a space, such as an underwater space. This data includes multiple voxels including a value characterizing a 3D point in the space. The computing device divides this data into slices representing a cross-section of the 3D volumetric view. The computing device clips one or more voxels in these slices based on a weighting function.

### FIELD

Embodiments presented herein generally relate to sonar imaging, and more specifically, to reducing less meaningful imaging data collected from sonar signals.

### BACKGROUND

A sonar generator may produce sonar imaging data by sending one or more sonar signal pulses into a volume of fluid, also known as insonifying the volume of fluid. Doing so causes objects within the insonified volume to reflect sound energy. One or more detector elements of a detector array may record the reflected sound energy. Generally, this process of transmitting sonar pulses, or pings, is repeated at a given frequency. Once the detector array receives reflected pings, each detector element may digitize and condition an analog electrical voltage signal to provide raw data indicative of the reflected sonar wave phase and intensity for each detector. Thereafter, the detector array may transform the raw data into beamformed data, which provides points in a three-dimensional (3D) space from where the signals were reflected. Beamforming the raw data produces a 3D array of intensity values corresponding to measurements within an insonified volume for a given ping. This 3D array representing a view volume is also referred to herein as full time series image data.

Typically, the detector array generates a large amount of beamformed data. In many cases, transmitting the entire set of data can be significantly cumbersome.

### SUMMARY

One embodiment presented herein discloses a method for processing sonar imaging data. The method generally discloses obtaining, by a processor, full time series image data representing a three-dimensional (3D) volumetric view of a space. The full time series image data includes a plurality of voxels, each voxel including a value characterizing a 3D point in the space. The method also generally discloses dividing, by the processor, the full time series image data into a plurality of slices. Each slice represents a cross-section of the 3D volumetric view. The method also generally discloses clipping, by the processor and from the full time series image data, one or more of the plurality of voxels per slice as a function of a weighting associated with the slice. The weighting is based on, for each slice, an average of the value of each voxel in the slice. The full time series image data resulting from the clipping is processed.

Another embodiment presented herein discloses a sonar computing device having a processor and a memory. The memory stores a plurality of instructions, which, when executed by the processor, causes the sonar computing device to obtain full time series image data representing a three-dimensional (3D) volumetric view of a space. The full time series image data includes a plurality of voxels, each voxel including a value characterizing a 3D point in the space. The full time series image data is divided into a plurality of slices. Each slice represents a cross-section of the 3D volumetric view. The plurality of instructions also causes the sonar computing device to clip, from the full time series image data, one or more of the plurality of voxels per slice as a function of a weighting associated with the slice. The weighting is based on, for each slice, an average of the value of each voxel in the slice. The full time series image data resulting from the clipping is processed.

Yet another embodiment presented herein discloses one or more machine-readable storage media storing instructions, which, when executed on a processor, cause a sonar computing device to obtain full time series image data representing a three-dimensional (3D) volumetric view of a space. The full time series image data includes a plurality of voxels, each voxel including a value characterizing a 3D point in the space. The full time series image data is divided into a plurality of slices. Each slice represents a cross-section of the 3D volumetric view. The instructions also cause the sonar computing device to clip, from the full time series image data, one or more of the plurality of voxels per slice as a function of a weighting associated with the slice. The weighting is based on, for each slice, an average of the value of each voxel in the slice. The full time series image data resulting from the clipping is processed.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified conceptual diagram of at least one embodiment of an example underwater environment in which sonar imaging data is processed;

FIG. 2 is a conceptual diagram of an example view volume representation;

FIG. 3 is a conceptual diagram of an example coordinate system for a three-dimensional world space;

FIG. 4 is a conceptual diagram of a volume of space of interest divided into a number of subsections corresponding to voxels of a view volume in world space;

FIG. 5 is a simplified block diagram of a computing device configured to process sonar imaging data;

FIG. 6 is a simplified flow diagram of a method for obtaining and transmitting sonar imaging data in a three-dimensional volumetric space;

FIG. 7 is a simplified flow diagram of a method for processing sonar imaging data;

FIG. 8 is a conceptual diagram of an example display of clipped sonar imaging data; and

FIG. 9 is a conceptual diagram of sonar imaging data displayed on an interface.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Generally, a sonar computing device may include a multi-element detector array that obtains an enormous amount of raw data underwater. The sonar computing device, prior to transmitting the data to a vessel system (e.g., for visualization or storage), preprocesses the data using techniques such as beamforming. Beamforming the data creates full time series image data that represents the underlying view volume of the space in front of a sonar sensor, in which the view volume is segmented into a regularly spaced three dimensional grid of voxels, each voxel being identified by its coordinates in a three-dimensional space and including a value or values, for example of intensity or intensity and phase, at its center. However, the full time series image data is often very large and includes a considerable amount of less meaningful elements, such as noise. Consequently, sending the beamformed data in its original state to the vessel system is inefficient.

Current approaches for reducing the amount of full time series image data are typically inadequate and can potentially remove meaningful data elements. Many approaches include some form of clipping, which pertains to a technique of removing data associated with a given voxel or voxels from the full time series data to ultimately reduce an overall amount of data as a result. For instance, threshold clipping evaluates each voxel in a view volume and removes data associated with voxels having an intensity value that does not exceed a specified threshold. However, such an approach may remove useful data associated with objects captured at a further distance from and/or with surfaces positioned at a shallower reflection angle with respect to the detector array. Such objects by nature would likely be represented as having relatively smaller intensity values compared to those representing objects closer in range of the detector array. To account for this, weighting the threshold as a function of range is possible but requires significant computing resources due to adjusting a gradient along the range for a given data source. Another approach involves identifying and clipping sidelobes around high-intensity data points in beamformed data. Such a technique, however, is imprecise and can result in not enough noise being removed or even too much meaningful data being removed. Therefore, an efficient and less cost-intensive approach is desired.

Embodiments presented herein disclose a system and techniques for processing sonar imaging data. More particularly, embodiments provide techniques for reducing an amount of less meaningful elements, such as noise, from the sonar imaging data as a function of properties associated with volume slices of beamformed data. For a given view volume, a volume slice corresponds to all voxels having an identical Z value with one another. Further, the XY values of the slice identify beam angles and place the center of the slice at (0,0). As indicated, at a given distance from the detector array, voxels corresponding to a given object may have intensity values that are relatively smaller the further away from the detector compared to voxels corresponding to a similar object closer to the detector array. Also, voxels corresponding to a given object may have intensity values that are relatively smaller the shallower the reflection angle of the signals reflected by the object with respect to the detector compared to voxels corresponding to a similar object with a less shallow, or steeper, reflection angle. In addition, consider the distribution of intensity values in a first slice and a second slice having the same average intensity. Assume the first slice generally contains noise (e.g., the first slice corresponds to a slice of the view volume representing a water column, which generally has low intensity values associated with each voxel), and the second slice includes a signal (e.g., a seabed at a greater distance from and/or at a shallow reflection angle with respect to the detector array). In such a case, a standard deviation in the distribution of intensity may be smaller in the first slice than in the second slice.

Given the properties above, it is possible to remove voxels from beamformed data per slice based on an average intensity value and also based on a standard deviation measure. As further described herein, clipping voxels in a slice based on an average intensity allows for distinguishing meaningful data from less meaningful data, such as noise. Each slice may be subject to a threshold that varies based on the average intensity, and intensity values that do not exceed the threshold are likely to correspond to noise. The threshold may correspond to a weighted average that is offset based on an inverse of standard deviation of intensity of data elements in the slice. Once clipped, the data may be normalized and compressed for transmission to the vessel, which, in turn may store or decompress the data for further processing.

The techniques described herein may be adapted to a computing device, such as a sonar computing device having a sonar signal generator that produces and emits sonar signals underwater. The sonar computing device may also include a multi-element detector array and transducer for receiving and processing reflected signals according to the embodiments disclosed herein.

Advantageously, embodiments disclosed herein provide an approach for clipping full time series image data to reduce the amount of less meaningful data, such as noise, from the data, while also being relatively less compute intensive compared to other clipping techniques. For example, by compressing the clipped beamformed data, the data occupies less storage resources, and transferring the data requires less bandwidth. Further, processing the clipped beamformed data requires less time and compute resources. Further still, the techniques disclosed herein for removing noise allow for better sonar image quality during a visualization process.

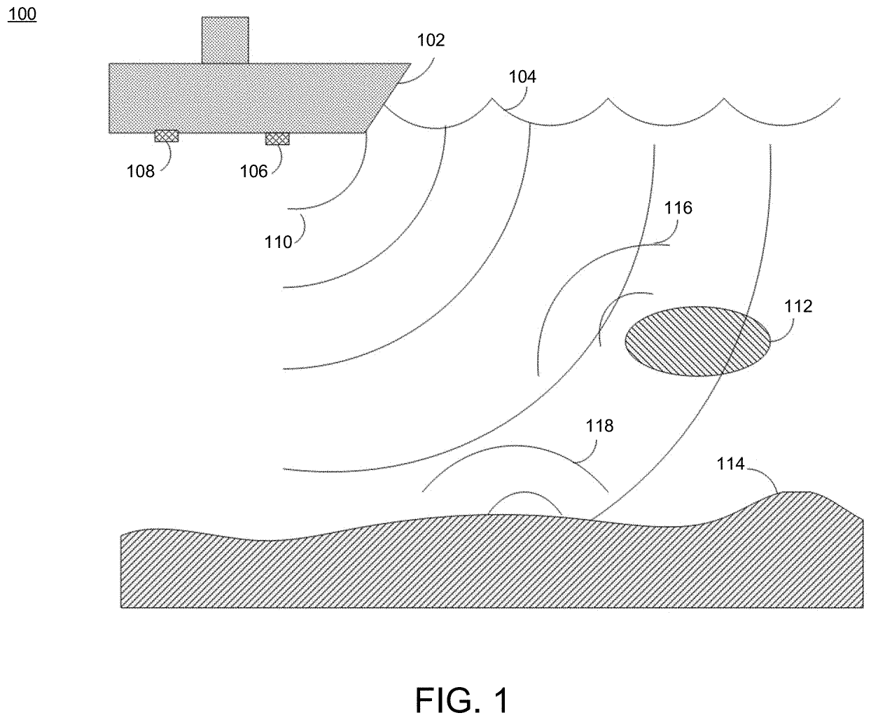

Referring now to FIG. 1, an example underwater environment 100 in which sonar imaging data is obtained and processed is shown. Illustratively, FIG. 1 depicts a sea vessel 102 atop an ocean 104. The sea vessel 102 may be embodied as any water vehicle capable of traveling a body of water, such as the ocean 104. The sea vessel 102 includes a number of sound navigation and ranging (SONAR) equipment, such as a sonar generator 106 and a detector 108. In an embodiment, the detector 108 may correspond to a multi-element array of detectors. Although depicted as separate components, the sonar generator 106 and detector 108 may be incorporated into a single sonar computing device. The sonar computing device may be adapted to a variety of settings, such as being attached to a cable or wire from the sea vessel 102, embodied within a robot, embodied within a remotely operated vehicle, and the like. Further, the sonar computing device (and individual components such as the sonar generator 106 and the detector 108) may include communication circuitry to send data collected and processed (e.g., segmentation data) to a remote device, such as a management console located within the sea vessel 102.

In an embodiment, the sonar generator 106 produces a sonar pulse. Illustratively, the sonar generator 106 insonifies a volume of fluid by transmitting a series of sound waves 110 in a relatively conical shape and pulsating at a given frequency. The pulses of the sound waves 110 are generally short (e.g., within a range of 10 to 100 microseconds) and spread relatively broadly over an angular range. Using known sonar-based techniques, the sonar equipment of the sea vessel 102 may derive raw imaging data indicative of an underwater scene from signals reflected by objects in the sea and received by the detector 108. Objects within range of the sound waves 110, such as a suspended object 112, seabed 114, or objects buried under the seabed 114 may reflect the sound waves, shown as sound waves 116 and 118 for the suspended object 112 and the seabed 114, respectively. Sound waves may also be re-reflected from the water surface of the ocean 104. Generally, a reflected ping signal (e.g., corresponding to sound waves 116 or 118) may arrive at the detector 108 in approximately twice the time taken for a ping signal (e.g., corresponding to sound waves 110) to the closest object in the insonified volume. A measurement of time continues until the reflected ping signal of a furthest object of interest reaches the detector 108. The total measurement time may be subdivided into a time slice, each having a slice distance, which may be set to match a predetermined range resolution and a corresponding time tₛ. Once the detector 108 receives reflected ping signals, each detector element may digitize and condition an analog electrical voltage signal to provide raw data representing reflected sonar wave phase and intensity in each time slice.

The sonar generator 106 may use a master oscillator square wave to provide pulses at a frequency 4f timed to edges of the master oscillator square wave. As a result, each element in the detector 108 may sample a received signal at phases 0, 90, 180, and 270 degrees of the master oscillator square wave. Sampling at 0 and 180 degrees provides real parts, and sampling at 90 and 270 degrees provides the imaginary parts of the phase of the reflected sound wave with respect to the master oscillator square wave. The sum of the squares of the real and imaginary parts provide the intensity of the sound wave at each individual detector. The detector 108 may sample the sound wave pressure with 10- or 12-bit accuracy. The reflected ping signals may be subdivided into a series of time slices having a slice time tₛ and a slice length lₛ. While different values for a time slice length, ping length, and sonar wavelength may be used, in practice, a time slice length of 4 cm, a ping length of 4 cm, and a sonar wavelength of 4 mm may produce desired results. Each time slice is numbered from t₁ to tₙ. Thus, for each time slice, the detector 108 may measure and window about ten wavelengths of the reflected sonar beam. Doing so generates a 10- or 12-bit imaginary number which gives the phase and intensity of the reflected wave measured by each detector for that time slice.

The detector 108 may use beamforming techniques on the digitized data to provide points in a three-dimensional (3D) space. The beamforming techniques may return beamformed data representing a view volume. More particularly, the beamformed data, also referred to herein as full time series image data, is a 3D array of intensity values corresponding to measurements from points contained within a given insonified volume for a given ping. Each intensity value is associated with a given voxel in the 3D space. The 3D array may represent a roughly conical volume in world space. In some cases, the voxel data may represent mosaicked multi-ping 3D sonar data of an insonified volume, in which a voxel includes at least the number of mosaicked 3D data sets including a signal at a given region of an insonified volume.

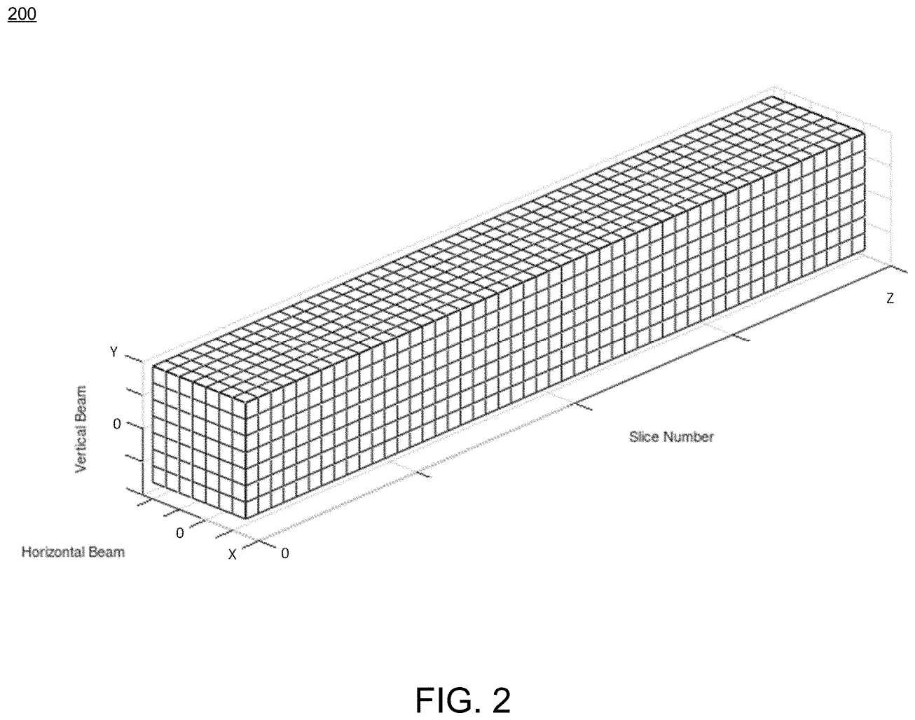

In an embodiment, the view volume may be represented as a cuboid. FIG. 2 shows an example of a cuboid 200 representing a view volume. Generally, the cuboid 200 represents a space facing the detector 108 within a given field of view (FoV_{X} by FoV_{Y}) that extends along an x-direction from a minimum value −FoV_{X}/2 to a maximum value FoV_{X}/2; along the y-direction from a minimum value of −FoV_{Y}/2 to a maximum value of FoV_{Y}/2; and along the z direction from a minimum range Min_{Range} to a maximum range Max_{Range}. Illustratively, the view volume is quantized in x, y and z to discrete values, splitting or segmenting the volume into a regularly spaced 3D grid of voxels, each voxel including at least one measured value (e.g., intensity) and positional information for the measured value. The voxels with the same value of z are at the same range or distance, which may be referred to as a ‘slice’. The X and Y values correspond to beam angles with the center of a given slice at (0,0). Each voxel may be identified by its coordinates in X, Y and Z and an intensity value and or phase.

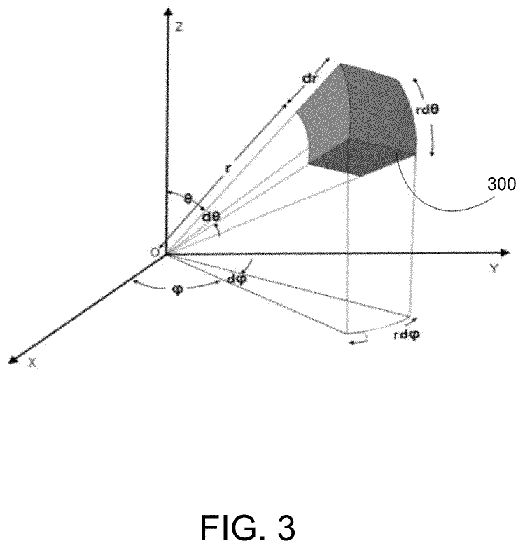

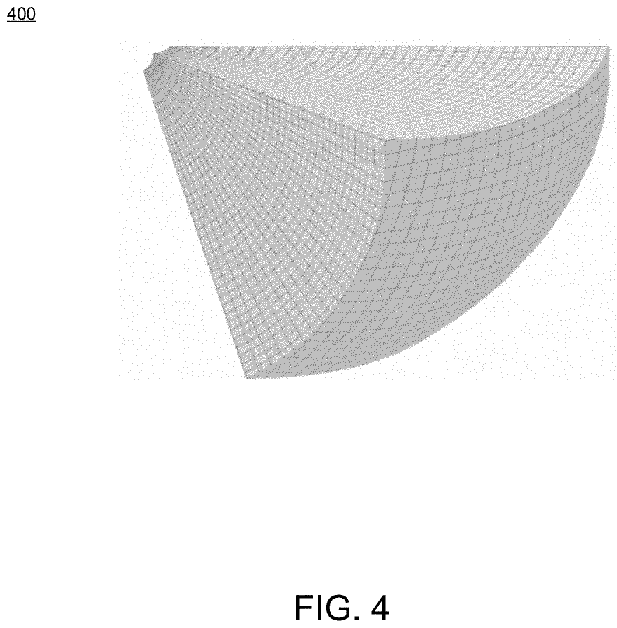

Further, in an embodiment, the sonar computing device may transform the view volume depicted in cuboid 200 into world space, in which data is represented in 3D space polar coordinates as a function of range and of two orthogonal angles relative to the plane of the detector 108. Doing so allows the sonar computing device to perform further processing and visualization with the data. Referring now to FIG. 3, a coordinate system in which one subsection of length δr having lateral dimensions r δθ and r δϕ is shown. As shown, the central point of the subsection 300 is located at range r and two orthogonal angular coordinates θ and ϕ. In world space, volume and component subsections corresponding to voxels in volume space may be represented by 3D pyramidal frusta including truncated pyramidal sections of a sphere between two radii. Referring briefly to FIG. 4, as shown, a volume of space of interest may be divided into a large number of subsections corresponding to voxels of the full time series image data. A beam corresponds to a set of touching subsections, wherein θ, ϕ, δθ and δϕ are fixed, and r runs from 1 to N. A beam represented by a set S_{rθϕ} has length N δ r, with voxels of the same length δ r and increasing values r δθ and r δϕ. Thus, the area of the beam is continually increasing further from the origin. Therefore, an intensity associated with a voxel in the view volume at a greater range or slice from the detector 108 corresponds to a significantly larger subsection volume, roughly proportional to the range squared, in world space when compared to an intensity in the view volume at a low range or volume slice closer to the detector 108.

Clipping voxels in volume slices based on an average in intensity and on a bias based on standard deviation may effectively account for the characteristics in intensity values of underlying objects at relative distances from the detector 108, e.g., to accurately detect an object further away from the detector 108 in addition to those closer thereto that may have a shallow reflection angle with respect to the detector. Particularly, average clipping per slice removes data associated with voxels having intensity values less than a fraction of an average intensity in the slice, offset by a specified value. The offset value may be proportional to a fixed or variable bias related to and applied across a full volume, a subset of slices in the volume, or per slice. In an embodiment, the bias is a constant and predetermined value that is fixed across the full volume. Further, a fraction of the bias may be added or subtracted from a fraction of a per slice average intensity, depending on preference of more or less data being included in the resulting data set.

In addition, the fraction of an average intensity of a slice may be proportional to a gain factor. The gain factor may be constant across the full volume and either predetermined or dependent on the data. Using a gain factor allows for normalization of the data, which results in visualization processes darkening or brightening the slice as a function of the values of the slice.

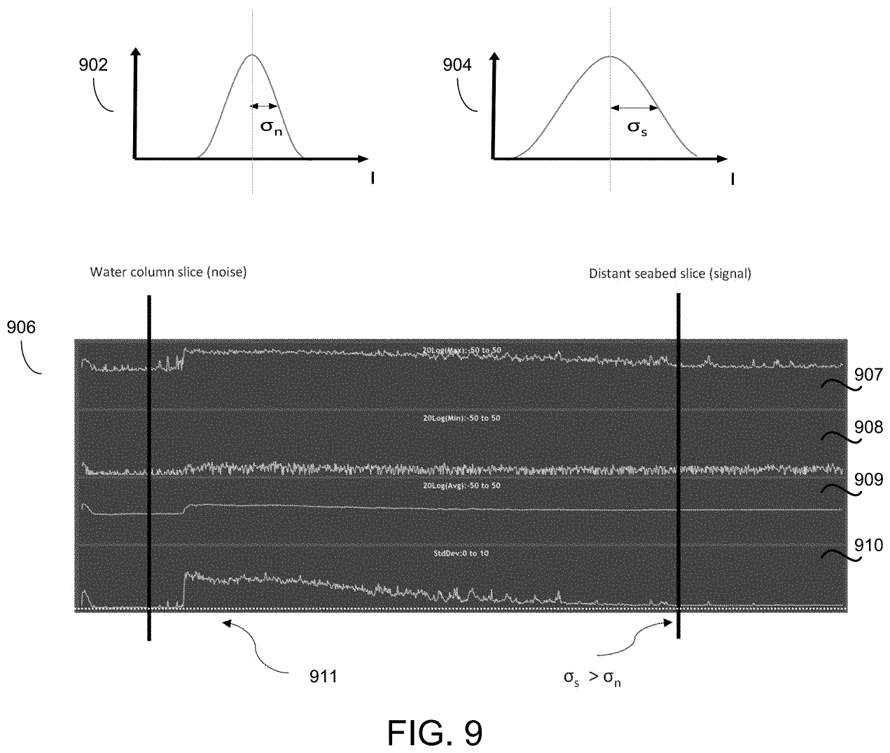

Further, referring briefly to FIG. 9, distributions 902 and 904 of intensity values in two volume slices with the same average intensity is shown. Particularly, the distribution 902 corresponds to a slice of a water column. Distribution 902 displays intensity values in a slice containing predominantly noise due to the signal being reflected from the water column. Further, the distribution 904 is of a distant seabed (e.g., the seabed 114, which is further in range from and at a swallow angle of reflection with respect to the detector 108). Therefore, the intensity values in a slice should contain predominantly signal. The standard deviation in the distribution of intensity values is smaller in distribution 902 (the slice containing the noise σₙ) than in distribution 902 (the slice containing the signal σₛ). Therefore, the inverse standard deviation of the intensities in slices containing noise is significantly higher than the inverse standard deviation of the intensities in slices containing signal. In the water column, the inverse standard deviation of the intensity is higher than the maximum value of the intensity, while in slices at a greater range and/or containing surfaces of objects positioned with shallow angles of reflection (lower intensity and greater noise) that contain data, the inverse standard deviation of the intensity is lower than the maximum value of the intensity. Therefore the inverse standard deviation 1/σ can be used to automatically remove noise, for example from the water column. Graph 906 maps the water column and seabed slices based on a standard deviation measure associated with each.

Graph 906 shows four graphs corresponding to a beamformed viewing volume segmented into approximately 1,200 volume slices. Each slice contains a number of data points corresponding to the intensities of the voxels in the slice at a given range. Graph 907 represents the maximum voxel intensity value in each slice along the full range of the volume. Graph 908 represents the minimum voxel intensity value in each slice along the full range of the volume. Graph 909 represents the average voxel intensity value in each slice along the full range of the volume. Graph 910 represents the standard deviation of the voxel intensity values in each slice along the full range of the volume. Dotted line 911 in graph 906 represents the average value of the standard deviation of noise, σₙ. The two vertical lines mark two slices of note: one at a close range containing signal from the water column (noise) and one at a distant range containing signal from a shallow seabed. The average value of both slices is comparable while the standard deviation of the intensities in the seabed slice is larger σₛ>σₙ.

In an embodiment, the standard deviation for a given slice may be represented as:

$${σ}_{slice} = \sqrt{\frac{{\sum }_{i = 1}^{n} {{I}_{i}}^{2} - {( {\sum }_{i = 1}^{n} {I}_{i} )}^{2}}{n}}$$

where Iᵢ is the intensity of a given data point and n is the number of data points in a given slice.

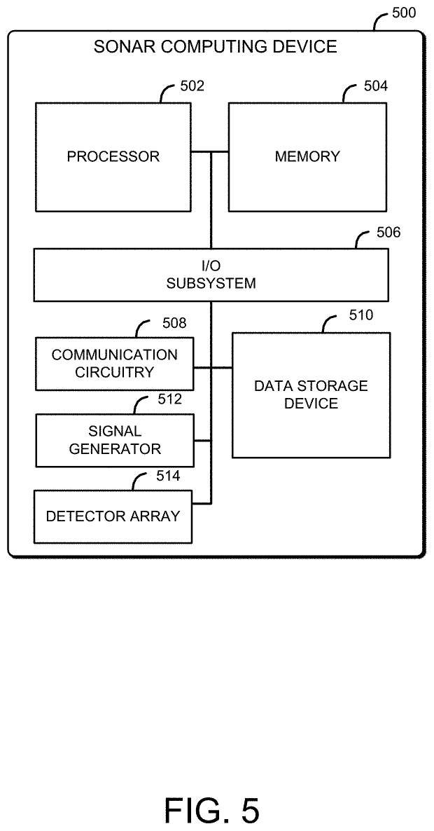

Referring now to FIG. 5, a sonar computing device 500 may be embodied as any type of device capable of performing the functions described herein, such as obtaining full time series image data representing a 3D volumetric view of a space, dividing the full time series image data into slices each representing a cross-section of the 3D volumetric view, clipping voxels in one or more of the slices as a function of a weighting of each of the slices based on a variance of the value in each voxel relative to the value in each other voxel within the slice, normalizing the clipped slice, and compressing the normalized data for transmission to the topside of the sea vessel 102.

As shown, the illustrative sonar computing device 500 includes a processor 502, a memory 504, an input/output (I/O) subsystem 506, communication circuitry 508, a data storage device 510, a signal generator 512, and a detector array 514. Of course, in other embodiments, the sonar computing device 500 may include other or additional components, such as those commonly found in a computer (e.g., display, peripheral devices, etc.) or as part of sonar equipment. Additionally, in some embodiments, one or more of the illustrative components may be incorporated in, or otherwise form a portion of, another component.

The processor 502 may be embodied as one or more processors, each processor being a type capable of performing the functions described herein. For example, the processor 502 may be embodied as a single or multi-core processor(s), a microcontroller, or other processor or processing/controlling circuit. In some embodiments, the processor 502 may be embodied as, include, or be coupled to a field programmable gate array (FPGA), an application-specific integrated circuit (ASIC), reconfigurable hardware or hardware circuitry, or other specialized hardware to facilitate performance of the functions described herein.

The memory 504 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, all or a portion of the memory 504 may be integrated into the processor 502.

The processor 502 and the memory 504 are communicatively coupled with other components of the sonar computing device 500 via the I/O subsystem 506, which may be embodied as circuitry and/or components to facilitate input/output operations with the processor 502 and/or the memory 504 and other components of the sonar computing device 500. For example, the I/O subsystem 506 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 506 may form a portion of a system-on-a-chip (SoC) and be incorporated, along with one or more of the processor 502, the memory 504, and other components of the sonar computing device 500.

The communication circuitry 508 may be embodied as any communication circuit, device, or collection thereof, capable of enabling communications over a network between the sonar computing device 500 and other devices (e.g., a management console on the sea vessel 102). The communication circuitry 508 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the communication circuitry 508 may include a network interface controller (NIC, not shown), embodied as one or more add-in-boards, daughtercards, controller chips, chipsets, or other devices that may be used by the sonar computing device 500 for network communications with remote devices. For example, the NIC may be embodied as an expansion card coupled to the I/O subsystem 506 over an expansion bus such as PCI Express.

The illustrative data storage device 510 may be embodied as any type of devices configured for short-term or long-term storage of data such as, for example, memory devices and circuits, memory cards, hard disk drives (HDDs), solid-state drives (SSDs), or other data storage devices. The data storage device 510 may include a system partition that stores data and firmware code for the data storage device 510. The data storage device 510 may also include an operating system partition that stores data files and executables for an operating system.

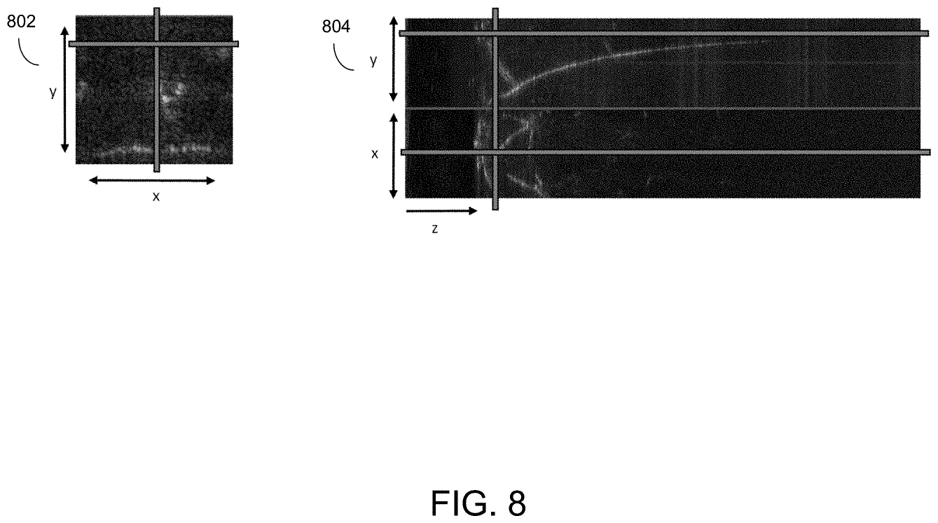

The signal generator 512 may be embodied as any type of device or circuitry capable of generating sonar pulse signals and transmitting the sonar pulse signals in a physical space. The detector array 514 may be embodied as any type of device or circuitry capable of receiving signals reflected by objects in response to contact with the generated sonar pulse signals. The detector array 514 may include a two-dimensional array of detector elements (e.g., hydrophones) arranged in a grid, e.g., a 48×48 grid comprising approximately 2,304 receive elements. Although depicted as separate components, the signal generator 512 and detector array 514 may be incorporated into a sonar equipment device housed within the sonar computing device 500. Turning briefly to FIG. 8, a 3D representation of views 802 and 804 of a piling structure and seabed from a multi-element sonar detector array. View 802 corresponds to a Z slab view projection along the Z direction of a given beam. Similarly, view 804 corresponds to Y and X slab view projections in the X and Y directions of the beam.

The sonar computing device 500 may establish an environment during operation in which the functions described herein are performed. The environment includes logic that may be carried out by one or more components of the sonar computing device 500 by execution of the processor 502, such as the signal generator 512, detector array 514, and memory 504.

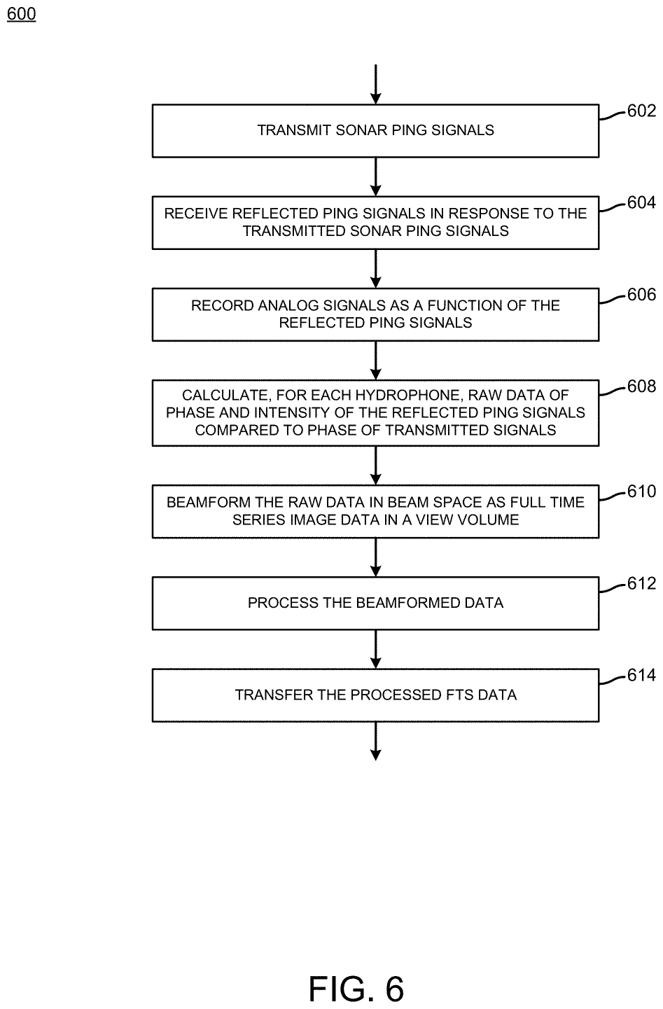

Referring now to FIG. 6, the sonar computing device 500, in operation, performs a method 600 for obtaining and managing sonar imaging data for further processing. As shown, the method 600 begins in block 602, in which the sonar computing device 500 transmits one or more sonar ping signals into a volume of fluid. Objects in the volume may reflect ping signals in response. In block 604, the sonar computing device 500 receives the reflected ping signals via the detector array.

In block 606, the sonar computing device 500, via each element in the detector array, records analog signals as a function of the reflected ping signals. Further, in block 608, each element in the detector array calculates raw data of the reflected ping signals. Particularly, each hydrophone element calculates phase and intensity values relative to the phase of the signal transmitted. In block 610, the sonar computing device 500 performs beamforming techniques on the calculated raw data to produce beamformed, or full time series image, data representing the view volume.

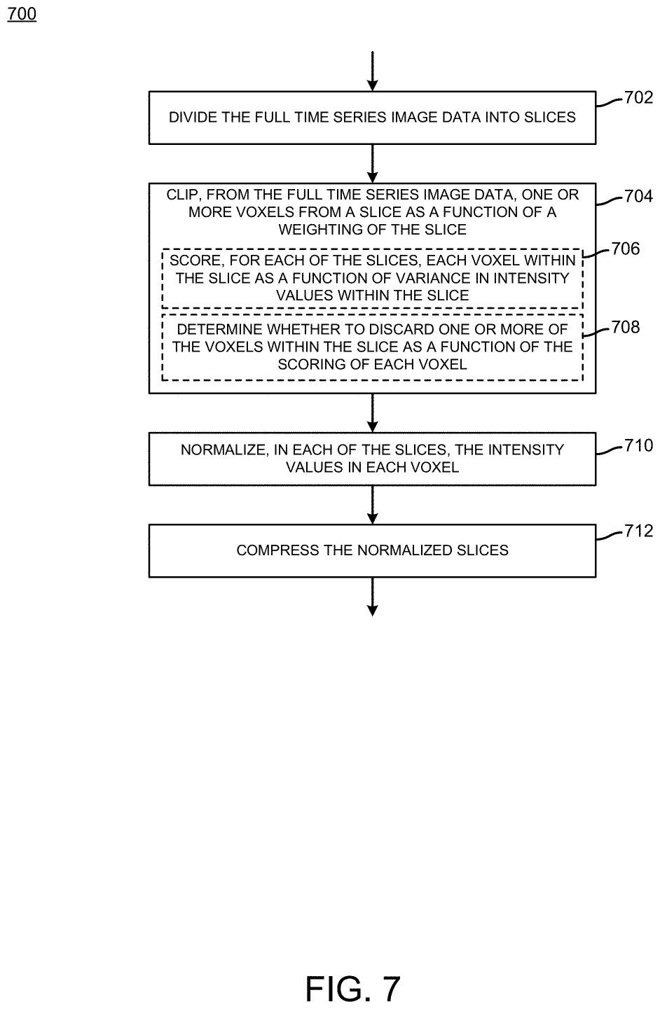

In block 612, the sonar computing device 500 processes the beamformed data. Particularly, the sonar computing device 500 clips less meaningful data from the full time series image data based on average intensity values and the standard deviation values of the voxels per slice. Thereafter, the sonar computing device 500 normalizes the voxel values in each slice and compresses the normalized data. These techniques are disclosed in further detail relative to FIG. 7. In block 614, the sonar computing device 500 transmits the compressed data. For example, the sonar computing device 500 may transmit the data to another processing function within the sonar computing device 500, such as a visualization or segmenting function. As another example, the sonar computing device 500 may transmit the data to a topside system on the sea vessel 102, such as a management console. As yet another example, sonar computing device 500 may transmit the data to a remote system outside the sea vessel 102, such as a cloud storage server. Once transmitted, the data may be uncompressed and further processed or stored.

Referring now to FIG. 7, the sonar computing device 500, in operation, may perform a method 700 for processing sonar imaging data, according to an embodiment. In this example method 700, assume that the sonar computing device 500 has received raw sonar data and beamformed the data to create full time series image data. As shown, the method 700 begins in block 702, in which the sonar computing device 500 divides the full time series image data into multiple volume slices. As stated, for a given view volume, a slice corresponds to voxels having an equal Z value, in which the X and Y values identify beam angles with the center of the slice being (0,0). The sonar computing device 500 may divide the full time series image data into slices based on a predetermined resolution and range, such as 1,200 slices.

Turning now to block 704, the sonar computing device 500 clips, from the full time series image data, one or more voxels from a slice as a function of a weighting for that slice. For instance, to do so, in block 706, the sonar computing device 500 scores, for each of the slices, each voxel within the slice as a function of variance in intensity values within the slice. Particularly, the sonar computing device 500 evaluates the intensity value in each of the voxels of the slice to determine at an average intensity for the slice. The sonar computing device 500 calculates the standard deviation for the voxels of the slice. Doing so allows the sonar computing device 500 to use the inverse of the standard deviation for weighting of voxels in the slice. High variances between voxels in the slice may indicate that the slice is less likely to have noise.

Further, in block 708, the sonar computing device 500 determines whether to discard one or more of the voxels within the slice as a function of the scoring of each voxel. In an embodiment, the sonar computing device 500 discards, in a slice, voxels having an intensity value below a slice-based threshold that is determined as a function of the intensity value of the voxel, the average intensity value of voxels in the slice, and an offset value. In an embodiment, the average intensity value is weighted proportional to a gain that is fixed for all slices in the volume. Further, in an embodiment, the offset is a bias that is fixed for all slices in the volume. Further still, in an embodiment, the offset is a bias weighted by the inverse of the standard deviation of values of at least some elements of a given slice.

Note, in some instances, a slice may include edges of an underlying object that have relatively low intensity values and thus may potentially be removed based on the average weighted and standard deviation clipping. In such cases, neighboring slices may include voxels having relatively higher intensity values, as these voxels in the neighboring slices would correspond to a portion of the object within the edges. In an embodiment, the sonar computing device 500 may evaluate low intensity voxels relative to voxels in neighboring slices to detect such instances and apply a filter to, for example, set the values in the low intensity voxels to those in the neighboring slice corresponding to the object.

In block 710, the sonar computing device 500 normalizes, in each of the slices, the intensity values in each voxel. Doing so preserves a full dynamic range of the data and also allows subsequent compression techniques to reduce a number of bits per value in the 3D array (e.g., from a floating point value to a 16-bit integer, an 8-bit integer, a 4-bit integer, 2-bit integer, 1-bit integer etc.) without significant data loss. More particularly, the sonar computing device 500 normalizes the each value such that the intensity of each is between 0 and 1, inclusive. For example, to normalize the intensity values, the sonar computing device 500 may perform a linearization technique using a given normalization factor. The sonar computing device 500 may replace any values exceeding the normalization factor with the normalization factor. Doing so saturates high value voxels to remove any spikes and dips in the data. In an embodiment, the normalization factor is associated by slice to allow for renormalization of the data at a subsequent processing stage. In block 712, the sonar computing device 500 compresses the normalized slices of data. For example, to do so, the sonar computing device 500 may compress the normalized data using a data structure such as an octree. Doing so allows the sonar computing device 500 to reduce an amount of bandwidth required to transmit the data for further processing, as discussed herein.

Further, as previously stated, the sonar computing device 500 may transform a view volume into world space. In an embodiment, the sonar computing device 500 may perform any one or combination of the clipping, normalization, and compression steps when the data corresponds geometrically to a conical insonified volume. In the case of data being a combination from multiple pings, the data sets may map to binned volumes (e.g., frusta) in world space when the data from multiple pings are mosaicked. From ping to ping, each binned volume may have a multiple count of data. Higher counts may correspond to data being present in all of the pings covering that bin. Some counts may have less, e.g., if shadows obscure reflections from an object in a given point in space for one or more pings. The bin count (or a weighting of a bin count and intensity values per bin) may be used as a data value for that given data point.

### EXAMPLES

Illustrative examples of the technologies disclosed herein are provided below. An embodiment of the technologies may include any one or more, and any combination of, the examples described below.

Example 1 includes a computer-implemented method for processing imaging data, the method comprising obtaining, by a processor, full time series image data representing a three-dimensional (3D) volumetric view of a space, the full time series image data including a plurality of voxels, each voxel including a value characterizing a 3D point in the space; dividing, by the processor, the full time series image data into a plurality of slices, each slice representing a cross-section of the 3D volumetric view; clipping, by the processor, from the full time series image data, one or more of the plurality of voxels per slice as a function of a weighting associated with the slice, wherein the weighting is based on, for each slice, an average of the value of each voxel in the slice; and processing, by the processor, the full time series image data resulting from the clipping.

Example 2 includes the subject matter of Example 1, and wherein clipping the one or more of the plurality of voxels per slice comprises determining, for at least a portion of the voxels within the slice, an inverse standard deviation measure of the portion of the voxels; scoring, for at least a portion of the plurality of slices, at least the portion of the voxels within the slice as a function of the inverse standard deviation measure; for at least a portion of the plurality of slices, determining whether to discard the data associated to one or more voxels in the slice as a function of the scoring of the voxels within the slice.

Example 3 includes the subject matter of any of Examples 1 and 2, and wherein determining whether to discard the one or more voxels in the slice is further determined as a function of the scoring of a first voxel within the slice relative to the scoring of second voxels neighboring the first voxel within the slice.

Example 4 includes the subject matter of any of Examples 1-3, and wherein determining whether to discard the one or more voxels in the slice is further determined as a function of the scoring of a first voxel within the slice relative to the scoring of second voxels within a neighboring slice.

Example 5 includes the subject matter of any of Examples 1-4, and wherein determining whether to discard one or more voxels in the slice comprises discarding, from the slice, each voxel in which the value is below a threshold determined as a function of the value of the voxel, the average of the values of the voxels in the slice, and a standard deviation measure of the values of the voxels in the slice.

Example 6 includes the subject matter of any of Examples 1-5, and further including, normalizing the value of the voxels in each slice of the full time series image data.

Example 7 includes the subject matter of any of Examples 1-6, and wherein normalizing the value of the voxels in each slice comprises replacing the value with a normalization factor in response to a determination that the value exceeds the normalization factor.

Example 8 includes the subject matter of any of Examples 1-7, and further including, compressing the clipped full time series image data.

Example 9 includes the subject matter of any of Examples 1-8, and wherein the value corresponds to an intensity of the respective voxel.

Example 10 includes the subject matter of any of Examples 1-9, and further including, sending one or more sonar signals from a sonar generator towards an underwater space, wherein the full time series image data represents sonar imaging data resulting from reflection of the one or more sonar signals.

Example 11 includes the subject matter of any of Examples 1-10, and wherein the plurality of voxels represent mosaicked multi-ping data.

Example 12 includes the subject matter of any of Examples 1-11, and wherein dividing the full time series image data into the plurality of slices comprises identifying the plurality of slices along a range direction in the 3D volumetric view.

Example 13 includes the subject matter of any of Examples 1-12, and wherein processing the full time series image data resulting from the clipping comprises constructing, by the processor, a 3D image of the full time series image data.

Example 14 includes a sonar computing device, comprising a processor; and a memory storing a plurality of instructions, which, when executed by the processor, causes the sonar computing device to obtain full time series image data representing a three-dimensional (3D) volumetric view of a space, the full time series image data including a plurality of voxels, each voxel including a value characterizing a 3D point in the space; divide the full time series image data into a plurality of slices, each slice representing a cross-section of the 3D volumetric view; clip, from the full time series image data, one or more of the plurality of voxels per slice as a function of a weighting associated with the slice, wherein the weighting is based on, for each slice, an average of the value of each voxel in the slice; and process the full time series image data resulting from the clipping.

Example 15 includes the subject matter of Example 14, and wherein to clip the one or more of the plurality of voxels per slice comprises to determine, for at least a portion of the voxels within the slice, an inverse standard deviation measure of the portion of the voxels; score, for at least a portion of the plurality of slices, at least the portion of the voxels within the slice as a function of the inverse standard deviation measure; for at least a portion of the plurality of slices, determine whether to discard the data associated to one or more voxels in the slice as a function of the scoring of the voxels within the slice.

Example 16 includes the subject matter of any of Examples 14 and 15, and wherein to determine whether to discard the one or more voxels in the slice is further determined as a function of the scoring of a first voxel within the slice relative to the scoring of second voxels neighboring the first voxel within the slice.

Example 17 includes the subject matter of any of Examples 14-16, and wherein to determine whether to discard the one or more voxels in the slice is further determined as a function of the scoring of a first voxel within the slice relative to the scoring of second voxels within a neighboring slice.

Example 18 includes the subject matter of any of Examples 14-17, and wherein to determine whether to discard one or more voxels in the slice comprises to discard, from the slice, each voxel in which the value is below a threshold determined as a function of the value of the voxel, the average of the values of the voxels in the slice, and a standard deviation measure of the values of the voxels in the slice.

Example 19 includes the subject matter of any of Examples 14-18, and further including a multi-element detector array to obtain an insonified volume representing the 3D volumetric view of the space.

Example 20 includes one or more machine-readable storage media storing instructions, which, when executed on a processor, causes a sonar computing device to obtain full time series image data representing a three-dimensional (3D) volumetric view of a space, the full time series image data including a plurality of voxels, each voxel including a value characterizing a 3D point in the space; divide the full time series image data into a plurality of slices, each slice representing a cross-section of the 3D volumetric view; clip, from the full time series image data, one or more of the plurality of voxels per slice as a function of a weighting associated with the slice, wherein the weighting is based on, for each slice, an average of the value of each voxel in the slice; and process the full time series image data resulting from the clipping.

1. A computer-implemented method for processing imaging data, the method comprising:
obtaining, by a processor, full time series image data representing a three-dimensional (3D) volumetric view of a space, the full time series image data including a plurality of voxels, each voxel including a value characterizing a 3D point in the space;
dividing, by the processor, the full time series image data into a plurality of slices, each slice representing a cross-section of the 3D volumetric view;
clipping, by the processor, from the full time series image data, one or more of the plurality of voxels per slice as a function of a weighting associated with the slice, wherein the weighting is based on, for each slice, an average of the value of each voxel in the slice; and
processing, by the processor, the full time series image data resulting from the clipping.

2. The method of claim 1, wherein clipping the one or more of the plurality of voxels per slice comprises:
determining, for at least a portion of the voxels within the slice, an inverse standard deviation measure of the portion of the voxels;
scoring, for at least a portion of the plurality of slices, at least the portion of the voxels within the slice as a function of the inverse standard deviation measure;
for at least a portion of the plurality of slices, determining whether to discard the data associated to one or more voxels in the slice as a function of the scoring of the voxels within the slice.

3. The method of claim 2, wherein determining whether to discard the one or more voxels in the slice is further determined as a function of the scoring of a first voxel within the slice relative to the scoring of second voxels neighboring the first voxel within the slice.

4. The method of claim 2, wherein determining whether to discard the one or more voxels in the slice is further determined as a function of the scoring of a first voxel within the slice relative to the scoring of second voxels within a neighboring slice.

5. The method of claim 2, wherein determining whether to discard one or more voxels in the slice comprises discarding, from the slice, each voxel in which the value is below a threshold determined as a function of the value of the voxel, the average of the values of the voxels in the slice, and a standard deviation measure of the values of the voxels in the slice.

6. The method of claim 1, further comprising, normalizing the value of the voxels in each slice of the full time series image data.

7. The method of claim 6, wherein normalizing the value of the voxels in each slice comprises replacing the value with a normalization factor in response to a determination that the value exceeds the normalization factor.

8. The method of claim 1, further comprising, compressing the clipped full time series image data.

9. The method of claim 1, wherein the value corresponds to an intensity of the respective voxel.

10. The method of claim 1, further comprising, sending one or more sonar signals from a sonar generator towards an underwater space, wherein the full time series image data represents sonar imaging data resulting from reflection of the one or more sonar signals.

11. The method of claim 1, wherein the plurality of voxels represent mosaicked multi-ping data.

12. The method of claim 1, wherein dividing the full time series image data into the plurality of slices comprises identifying the plurality of slices along a range direction in the 3D volumetric view.

13. The method of claim 1, wherein processing the full time series image data resulting from the clipping comprises constructing, by the processor, a 3D image of the full time series image data.

14. A sonar computing device, comprising:
a processor; and
a memory storing a plurality of instructions, which, when executed by the processor, causes the sonar computing device to:
obtain full time series image data representing a three-dimensional (3D) volumetric view of a space, the full time series image data including a plurality of voxels, each voxel including a value characterizing a 3D point in the space;
divide the full time series image data into a plurality of slices, each slice representing a cross-section of the 3D volumetric view;
clip, from the full time series image data, one or more of the plurality of voxels per slice as a function of a weighting associated with the slice, wherein the weighting is based on, for each slice, an average of the value of each voxel in the slice; and
process the full time series image data resulting from the clipping.

15. The sonar computing device of claim 14, wherein to clip the one or more of the plurality of voxels per slice comprises to:
determine, for at least a portion of the voxels within the slice, an inverse standard deviation measure of the portion of the voxels;
score, for at least a portion of the plurality of slices, at least the portion of the voxels within the slice as a function of the inverse standard deviation measure;
for at least a portion of the plurality of slices, determine whether to discard the data associated to one or more voxels in the slice as a function of the scoring of the voxels within the slice.

16. The sonar computing device of claim 15, wherein to determine whether to discard the one or more voxels in the slice is further determined as a function of the scoring of a first voxel within the slice relative to the scoring of second voxels neighboring the first voxel within the slice.

17. The sonar computing device of claim 15, wherein to determine whether to discard the one or more voxels in the slice is further determined as a function of the scoring of a first voxel within the slice relative to the scoring of second voxels within a neighboring slice.

18. The sonar computing device of claim 15, wherein to determine whether to discard one or more voxels in the slice comprises to discard, from the slice, each voxel in which the value is below a threshold determined as a function of the value of the voxel, the average of the values of the voxels in the slice, and a standard deviation measure of the values of the voxels in the slice.

19. The sonar computing device of claim 14, further comprising a multi-element detector array to obtain an insonified volume representing the 3D volumetric view of the space.

20. One or more machine-readable storage media storing instructions, which, when executed on a processor, cause a sonar computing device to:
obtain full time series image data representing a three-dimensional (3D) volumetric view of a space, the full time series image data including a plurality of voxels, each voxel including a value characterizing a 3D point in the space;
divide the full time series image data into a plurality of slices, each slice representing a cross-section of the 3D volumetric view;
clip, from the full time series image data, one or more of the plurality of voxels per slice as a function of a weighting associated with the slice, wherein the weighting is based on, for each slice, an average of the value of each voxel in the slice; and
process the full time series image data resulting from the clipping.
